(19) United States
(12) Patent Application Publication
(10) Pub. No.: US 2023/0063740 A1
(43) Pub. Date: Mar. 2, 2023

(54) COMMUNICATION SYSTEM, BASE STATION, AND COMMUNICATION CONTROL METHOD

(71) Applicant: KYOCERA Corporation, Kyoto (JP)

(72) Inventors: Hiroki FUJITA, Yokohama-shi (JP); Tatsunori ARAKI, Yamato-shi (JP)

(73) Assignee: KYOCERA Corporation, Kyoto (JP)

(21) Appl. No.: 18/047,929

(22) Filed: Oct. 19, 2022

Related U.S. Application Data
(63) Continuation of application No. PCT/JP2021/015611, filed on Apr. 15, 2021.

(30) Foreign Application Priority Data
Apr. 24, 2020 (JP) 2020-077777

(51) Int. Cl. H04W 56/00; H04L 61/50

(52) U.S. Cl. CPC H04W 56/001; H04L 61/50; H04L 2101/622

(57) ABSTRACT

A traffic communication system 1 that performs inter-roadside communication being wireless communication between roadside devices 200 includes a roadside device 200A that transmits a message including a MAC address field through inter-roadside communication, and a roadside device 200B that receives the message through inter-roadside communication. The roadside device 200A stores synchronization information in at least a part of the MAC address field. The synchronization information is information different from a MAC address and is used for synchronization between the roadside devices 200.

### RELATED APPLICATIONS

The present application is a continuation based on PCT Application No. PCT/JP2021/015611, filed on Apr. 15, 2021, which claims the benefit of Japanese Patent Application No. 2020-077777 filed on Apr. 24, 2020. The content of which is incorporated by reference herein in their entirety.

### TECHNICAL FIELD

The present invention relates to a communication system, a base station, and a communication control method.

### BACKGROUND OF INVENTION

In recent years, Intelligent Transport Systems (ITSs) have attracted attention as technology for enabling avoidance of insecurity of traffic accidents.

As one such system, Non-Patent Literature 1 describes a system including a roadside device corresponding to a base station installed on a roadside, and an in-vehicle device corresponding to a mobile station installed in a vehicle, the roadside device and the in-vehicle device performing wireless communication.

### CITATION LIST

### Non-Patent Literature

Non-Patent Literature 1: ARIB STD-T109 1.3 version “700 MHz Band Intelligent Transport System”

### SUMMARY

In a first aspect, a communication system is a communication system for performing inter-base station communication, which is wireless communication between base stations. The communication system includes a first base station configured to transmit a message including a medium access control (MAC) address field through inter-base station communication, and a second base station configured to receive the message through the inter-base station communication. The first base station stores synchronization information in at least a part of the MAC address field. The synchronization information is information different from a MAC address and is used for synchronization between base stations.

In a second aspect, a base station is a base station for performing inter-base station communication, which is wireless communication between base stations. The base station includes a communicator configured to transmit a message including a medium access control (MAC) address field through inter-base station communication. The communicator stores synchronization information in at least a part of the MAC address field. The synchronization information is information different from a MAC address and is used for synchronization between base stations.

In a third aspect, a base station is a base station for performing inter-base station communication, which is wireless communication between base stations. The base station includes a communicator configured to receive a message including a medium access control (MAC) address field through the inter-base station communication. The communicator receives the message storing synchronization information in at least a part of the MAC address field. The synchronization information is information different from a MAC address and is used for synchronization between base stations.

In a fourth aspect, a communication control method is a communication control method of performing inter-base station communication, which is wireless communication between base stations in a communication system. The communication control method includes transmitting, by a first base station, a message including a medium access control (MAC) address field through inter-base station communication, and receiving, by a second base station, the message through the inter-base station communication. The first base station stores synchronization information in at least a part of the MAC address field. The synchronization information is information different from a MAC address and is used for synchronization between base stations.

### BRIEF DESCRIPTION OF THE DRAWINGS

FIG. 1 is a diagram illustrating a configuration of a traffic communication system according to an embodiment.

FIG. 2 is a diagram illustrating a configuration of a roadside device according to an embodiment.

FIG. 3 is a diagram illustrating a configuration of a vehicle according to an embodiment.

FIG. 4 is a diagram for illustrating operation of a roadside device according to an embodiment.

FIG. 5 is a diagram illustrating an example of a transmission source MAC address field of an inter-roadside communication message according to an embodiment.

FIG. 6 is a diagram illustrating operation pattern 1 according to an embodiment.

FIG. 7 is a diagram illustrating operation pattern 2 according to an embodiment.

FIG. 8 is a diagram illustrating GNSS synchronization according to a variation.

FIG. 9 is a diagram illustrating air synchronization according to a variation.

FIG. 10 is a diagram illustrating operation pattern 1 according to a variation.

FIG. 11 is a diagram illustrating operation pattern 2 according to a variation.

### DESCRIPTION OF EMBODIMENTS

In the communication system as described above, if adjacent base stations are not synchronized with each other, interference occurs between the base stations, unfortunately.

In view of this, the present disclosure has an object to enable efficient synchronization between base stations.

A traffic communication system being a communication system according to an embodiment will be described with reference to the drawings. Note that in the following description of the drawings, the same or similar components will be denoted by the same or similar reference signs.

Configuration of Traffic Communication System

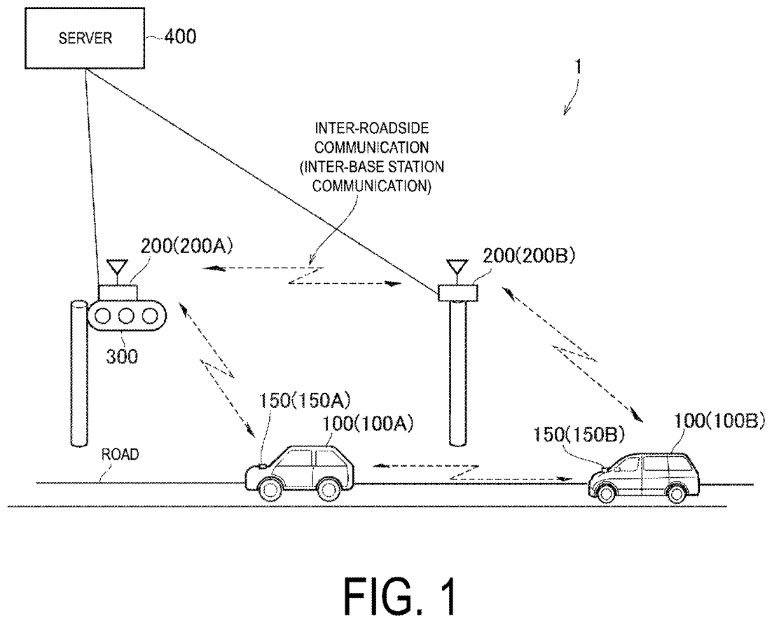

First, a configuration of a traffic communication system according to an embodiment will be described. FIG. 1 is a diagram illustrating a configuration of a traffic communication system 1 according to an embodiment.

As illustrated in FIG. 1, the traffic communication system 1 includes vehicles 100 passing through a road, and roadside devices 200 corresponding to base stations installed on the roadside of the road. The vehicle 100 is an example of a moving body.

FIG. 1 illustrates vehicles 100A and 100B as the vehicles 100, and illustrates roadside devices 200A and 200B as the roadside devices 200. The vehicles 100 are illustrated as an automobile such as an ordinary automobile and a light automobile, but may be any vehicle passing through a road, for example, a two-wheel motor vehicle (motorcycle) or the like.

Each vehicle 100 is equipped with an in-vehicle device 150 corresponding to a mobile station for performing wireless communication. The in-vehicle device 150 performs wireless communication (that is, roadside-to-vehicle communication) with the roadside device 200. In FIG. 1, an example is illustrated in which an in-vehicle device 150A and the roadside device 200A perform roadside-to-vehicle communication, and an in-vehicle device 150B and the roadside device 200B perform roadside-to-vehicle communication. The in-vehicle device 150 may perform wireless communication (that is, inter-vehicle communication) with another in-vehicle device 150.

Each roadside device 200 is installed near a road. Each roadside device 200 may be installed at an intersection at which two or more roads intersect. The roadside device 200A is installed in a traffic light 300 or a support thereof, and operates in cooperation with the traffic light 300. The roadside device 200B is installed in a support.

Each roadside device 200 performs roadside-to-vehicle communication with the vehicle 100. For example, the roadside device 200A transmits, to the in-vehicle device 150, a radio signal including signal information related to the traffic light 300. For such roadside-to-vehicle communication, broadcast wireless communication for a large number of unspecified destinations may be used. For the roadside-to-vehicle communication, multicast wireless communication for a large number of specified destinations may be used, or unicast wireless communication for a single specified destination may be used.

Each roadside device 200 performs wireless communication (that is, inter-roadside communication) with another roadside device 200. The inter-roadside communication is an example of inter-base station communication. For such inter-roadside communication, broadcast wireless communication for a large number of unspecified destinations may be used. For the inter-roadside communication, multicast wireless communication for a large number of specified destinations may be used, or unicast wireless communication for a single specified destination may be used. The following will mainly describe an example in which broadcast is used for the inter-roadside communication.

Each roadside device 200 is connected to a server 400 via a communication line. The communication line may be a wired line or a wireless line. The server 400 manages each roadside device 200.

Configuration of Roadside Device

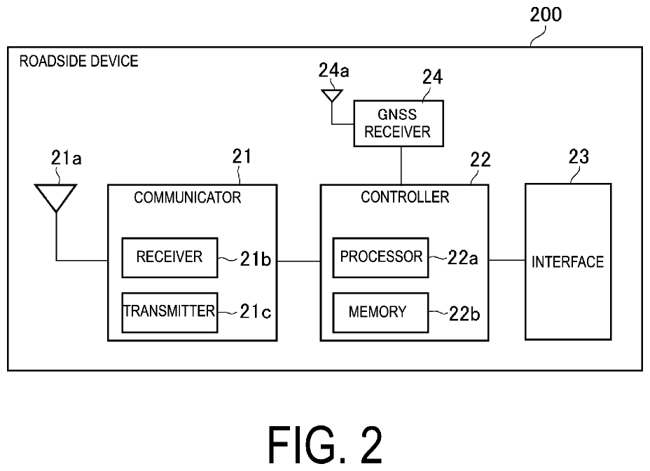

In an embodiment, a configuration of the roadside device 200 will be described. FIG. 2 is a diagram illustrating the configuration of the roadside device 200 according to an embodiment.

As illustrated in FIG. 2, the roadside device 200 includes a communicator 21, a controller 22, an interface 23, and a Global Navigation Satellite System (GNSS) receiver 24.

Under control of the controller 22, the communicator 21 performs roadside-to-vehicle communication with the in-vehicle device 150, and also performs inter-roadside communication with another roadside device 200 (adjacent roadside device).

The communicator 21 includes an antenna 21a, a receiver 21b, and a transmitter 21c, and performs wireless communication via the antenna 21a. The antenna 21a may be a non-directional antenna, or may be a directional antenna having directivity. The antenna 21a may be an adaptive array antenna that can dynamically change its directivity. The receiver 21b converts a radio signal received by the antenna 21a into receive data and outputs the receive data to the controller 22. The transmitter 21c converts transmit data output by the controller 22 into a radio signal and transmits the radio signal from the antenna 21a.

The wireless communication scheme of the communicator 21 may be a scheme conforming to the T109 standard of Association of Radio Industries and Businesses (ARIB), a scheme conforming to the Vehicle-to-everything (V2X) standard of Third Generation Partnership Project (3GPP), or a scheme conforming to the wireless Local Area Network (LAN) standard such as the Institute of Electrical and Electronics Engineers (IEEE) 802.11 series. The communicator 21 may conform to two or more of these communication standards. The following will mainly describe an example in which the communicator 21 performs wireless communication by using the scheme conforming to the T109 standard of ARIB.

The controller 22 controls various functions of the roadside device 200. The controller 22 includes at least one memory 22b and at least one processor 22a electrically connected to the memory 22b. The memory 22b includes a volatile memory and a non-volatile memory and stores information used for processing in the processor 22a and programs executed by the processor 22a. The memory 22b corresponds to storage. The processor 22a executes the programs stored in the memory 22b to perform various processing operations.

The interface 23 is connected to the server 400 via a wired line and/or wireless line. The interface 23 may be electrically connected to the traffic light 300.

The GNSS receiver 24 receives a GNSS signal from a GNSS satellite via an antenna 24a. The GNSS receiver 24 includes, for example, a receiver for at least one GNSS out of the Global Positioning System (GPS), the Global Navigation Satellite System (GLONASS), the Indian Regional Navigational Satellite System (IRNSS), COMPASS, and Galileo. The following will mainly describe an example in which the GNSS receiver 24 includes a GPS receiver.

Configuration of Vehicle

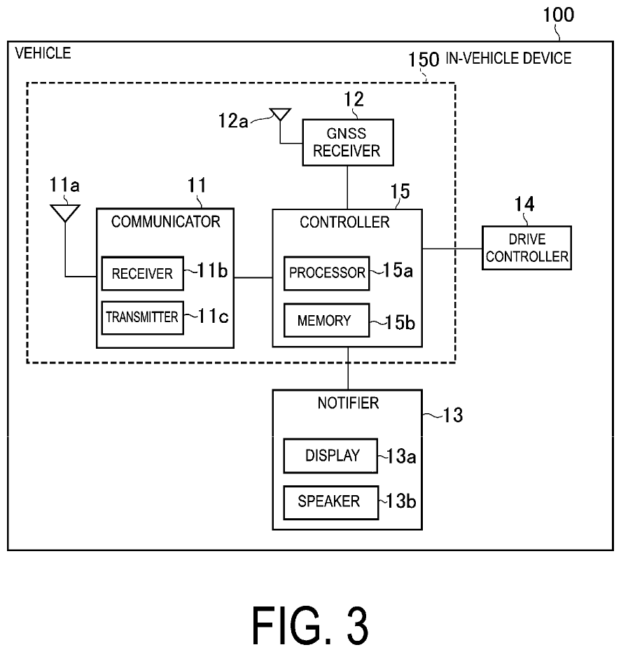

In an embodiment, a configuration of the vehicle 100 will be described. FIG. 3 is a diagram illustrating a configuration of the vehicle 100 according to an embodiment.

As illustrated in FIG. 3, the vehicle 100 includes a communicator 11, a GNSS receiver 12, a notifier 13, a drive controller 14, and a controller 15. The communicator 11, the GNSS receiver 12, and the controller 15 constitute the in-vehicle device 150.

The communicator 11 performs roadside-to-vehicle communication with the roadside device 200. The communicator 11 may perform wireless communication (that is, inter-vehicle communication) with another vehicle 100 (another in-vehicle device 150). Specifically, the communicator 11 includes an antenna 11a, a receiver 11b, and a transmitter 11c, and performs wireless communication via the antenna 11a. The receiver 11b converts a radio signal received by the antenna 11a into receive data and outputs the receive data to the controller 15. The transmitter 11c converts the transmit data output by the controller 15 into a radio signal and transmits the radio signal from the antenna 11a.

The radio communication scheme of the communicator 11 may be a scheme conforming to the T109 standard of the ARIB, a scheme conforming to the V2X standard of the 3GPP, or a scheme conforming to a wireless LAN standard such as the IEEE 802.11 series. The communicator 11 may conform to two or more of these communication standards. The following will mainly describe an example in which the communicator 21 performs wireless communication by using the scheme conforming to the T109 standard of ARIB.

The GNSS receiver 12 receives a GNSS signal from a GNSS satellite via an antenna 12a. The GNSS receiver 12 includes, for example, a receiver for at least one GNSS out of GPS, GLONASS, IRNSS, COMPASS, and Galileo. The following will mainly describe an example in which the GNSS receiver 12 includes a GPS receiver.

Under the control of the controller 15, the notifier 13 notifies a driver of the vehicle 100 of information. The notifier 13 includes a display 13a that displays information, and a speaker 13b that auditorily outputs information.

The drive controller 14 controls an engine or a motor as a source of power, a power transmission mechanism, brakes, and the like. When the vehicle 100 is an automatic driving vehicle, the drive controller 14 may control operation of the vehicle 100 in cooperation with the controller 15.

The controller 15 controls various functions of the vehicle 100 (in-vehicle device 150). The controller 15 includes at least one memory 15b and at least one processor 15a electrically connected to the memory 15b. The memory 15b includes a volatile memory and a non-volatile memory and stores information used for processing in the processor 15a and programs executed by the processor 15a. The processor 15a executes programs stored in the memory 15b to perform various processing.

Operations of Roadside Device

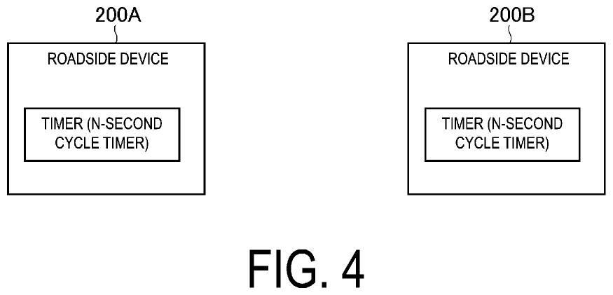

In an embodiment, operations of the roadside device 200 will now be described. FIG. 4 is a diagram for illustrating operations of the roadside device 200 according to an embodiment.

As illustrated in FIG. 4, the controller 22 of each roadside device 200 (roadside devices 200A and 200B) manages a timer that determines a transmission cycle in inter-roadside communication. The transmission cycle is variable, and the timer that counts such a variable transmission cycle is referred to as an “N-second cycle timer”.

The controller 22 of each roadside device 200 manages the N-second cycle timer, and thereby controls the communicator 21 so as to transmit a message of inter-roadside communication with the transmission cycle of N seconds. Such transmission cycles of N seconds need to match between close roadside devices 200.

Offset time is set for each roadside device 200 so that transmission timings (transmission time slots) of inter-roadside communication do not collide with each other between close roadside devices 200.

For example, when the offset time set for the roadside device 200A is “0 ms” and the transmission cycle of N seconds is “300 ms”, the roadside device 200A transmits a message of inter-roadside communication at each of the timings (each of the time slots) such as “0 ms”, “300 ms”, and “600 ms”.

On the other hand, when the offset time set for the roadside device 200B is “100 ms” and the transmission cycle of N seconds is “300 ms”, the roadside device 200A transmits a message of inter-roadside communication at each of the timings (each of the time slots) such as “100 ms”, “400 ms”, and “700 ms”.

In this manner, when the transmission cycles (N seconds) of inter-roadside communication of respective roadside devices 200 match, and the current values of the N-second cycle timers of the respective roadside devices 200 match, the transmission timings (transmission time slots) of inter-roadside communication do not collide with each other between close roadside devices 200. Thus, interference of inter-roadside communication can be prevented from occurring between the roadside devices 200.

However, when the transmission cycles (N seconds) of inter-roadside communication of respective roadside devices 200 do not match, and/or the current values of the N-second cycle timers of the respective roadside devices 200 do not match, the transmission timings (transmission time slots) of inter-roadside communication may collide with each other between close roadside devices 200. Thus, interference of inter-roadside communication may occur between the roadside devices 200. In other words, when close roadside devices 200 are not synchronized regarding the transmission cycles of inter-roadside communication, interference of inter-roadside communication may occur between the roadside devices 200.

The following will describe operation of the roadside devices 200 to be synchronized with each other regarding the transmission cycles of inter-roadside communication.

In an embodiment, the roadside devices 200A and 200B perform inter-roadside communication being wireless communication between the roadside devices 200. The roadside device 200A is an example of a first base station, and the roadside device 200B is an example of a second base station.

The roadside device 200A transmits a message (hereinafter referred to as an “inter-roadside communication message”) having a medium access control (MAC) address field through inter-roadside communication. Such an inter-roadside communication message may be referred to as an inter-roadside communication packet. The roadside device 200B receives the inter-roadside communication message from the roadside device 200A. Specifically, the roadside device 200B is installed near the roadside device 200A, and is present within a range where radio waves from the roadside device 200A can reach.

In an embodiment, the roadside device 200A transmits the inter-roadside communication message using broadcasting. For example, the inter-roadside communication message does not include a destination MAC address, or includes a broadcast address as the destination MAC address. Note that a MAC address is also referred to as a link address.

The inter-roadside communication message includes an identifier for identifying the roadside device 200A. The identifier is managed in a layer (for example, an application layer) that is higher than a MAC layer. Note that the identifier is different from the MAC address of the roadside device 200A.

Under the presupposition as described above, a transmission source MAC address field for storing the MAC address of the roadside device 200A need not be present in the inter-roadside communication message transmitted by the roadside device 200A. Specifically, in broadcast inter-roadside communication, the necessity of identifying a transmission source of the inter-roadside communication message is low. Even when the transmission source of the inter-roadside communication message needs to be identified, the transmission source of the inter-roadside communication message can be identified using an identifier managed in a higher layer.

The roadside device 200A stores synchronization information, which is information different from the MAC address and is used for synchronization between the roadside devices 200, in at least a part of the MAC address field included in the inter-roadside communication message. In an embodiment, the MAC address field is a transmission source MAC address field for storing the MAC address of the roadside device 200A.

With this configuration, the synchronization information can be transmitted to another roadside device 200 (roadside device 200B) with the use of the transmission source MAC address field of the inter-roadside communication message, without an additional field being provided for an existing format of the inter-roadside communication message. In other words, the synchronization information can be efficiently transmitted to another roadside device 200 (roadside device 200B), with the format of the inter-roadside communication message defined in an existing standard being maintained.

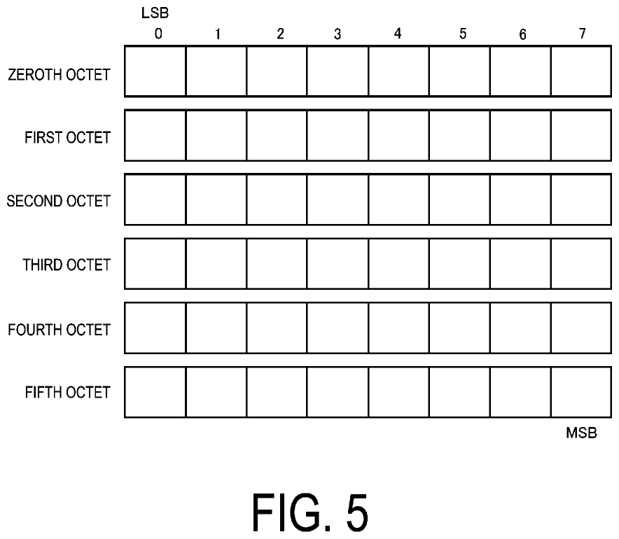

FIG. 5 is a diagram illustrating an example of the transmission source MAC address field of the inter-roadside communication message according to an embodiment.

As illustrated in FIG. 5, the transmission source MAC address field includes a total of six octets of the zeroth octet to the fifth octet. Of these six octets, for example, a total of two octets of the fourth octet and the fifth octet are assigned to the synchronization information. All of these six octets may be assigned to the synchronization information.

When the total of two octets of the fourth octet and the fifth octet are assigned to the synchronization information, the zeroth octet to the third octet can be assigned to the transmission source MAC address, but a part of the transmission source MAC address may lack. However, lack of a part thereof may be acceptable since, as described above, the transmission source MAC address is not important information. Note that the roadside device 200A may store a complete transmission source MAC address in the transmission source MAC address field without storing the synchronization information in the transmission source MAC address field at a rate of once in multiple times. With this configuration, the roadside device 200B can supplement the part lacking in the transmission source MAC address received later by using the complete transmission source MAC address received earlier.

In an embodiment, the synchronization information stored in the transmission source MAC address of the inter-roadside communication message includes timer related information that is related to the N-second cycle timer managed by the roadside device 200A. With this configuration, the roadside device 200B can synchronize the N-second cycle timer managed by the roadside device 200B with the N-second cycle timer managed by the roadside device 200A by using the timer related information stored in the transmission source MAC address of the inter-roadside communication message.

For example, the timer related information includes at least one of a cycle value (hereinafter referred to as an “N value”) indicating the transmission cycle (N seconds) of the inter-roadside communication message and the current value of the N-second cycle timer. The timer related information may further include offset time of transmission of the inter-roadside communication message.

(1) Operation Pattern 1

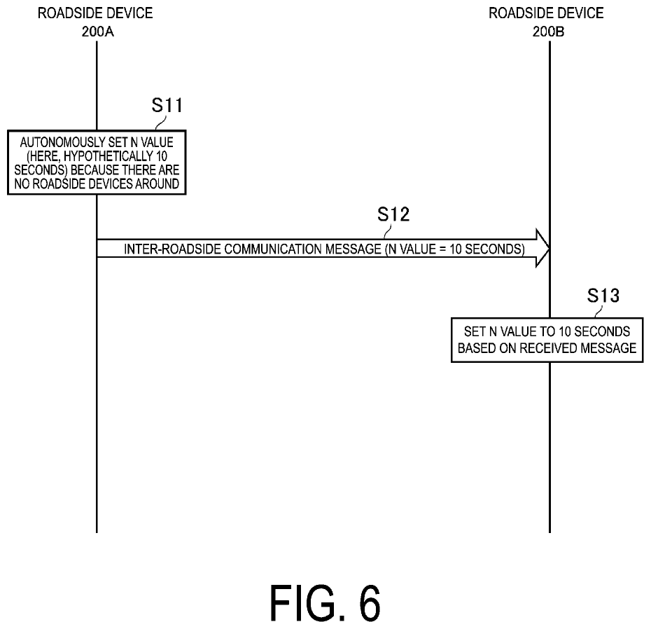

FIG. 6 is a diagram illustrating operation pattern 1 according to an embodiment. In the present operation pattern, of the roadside devices 200A and 200B, the roadside device 200A starts first, and subsequently the roadside device 200B starts.

As illustrated in FIG. 6, in Step S11, when the roadside device 200A starts, the controller 22 of the roadside device 200A determines whether the communicator 21 of the roadside device 200A has received the inter-roadside communication message. When the communicator 21 of the roadside device 200A cannot receive the inter-roadside communication message, the controller 22 of the roadside device 200A determines that there are no other roadside devices 200 around the roadside device 200A, and autonomously sets the N value. Here, the set N value may be, for example, a value notified from the server 400 to the roadside device 200A. FIG. 6 illustrates an example in which the set N value is 10 seconds.

In Step S12, the controller 22 of the roadside device 200A controls the communicator 21 of the roadside device 200A so as to transmit the inter-roadside communication message using broadcasting. Here, the controller 22 of the roadside device 200A controls the communicator 21 of the roadside device 200A so as to store the N value set in Step S11 in a part of the transmission source MAC address field of the inter-roadside communication message. The communicator 21 of the roadside device 200B receives the inter-roadside communication message from the roadside device 200A.

In Step S13, the controller 22 of the roadside device 200B sets the N value of the roadside device 200B, based on the inter-roadside communication message received by the communicator 21 of the roadside device 200B. Specifically, the controller 22 of the roadside device 200B makes the N value of the roadside device 200B match the N value stored in the transmission source MAC address field of the received inter-roadside communication message. With this configuration, the N values of the respective roadside devices 200A and 200B match.

(2) Operation Pattern 2

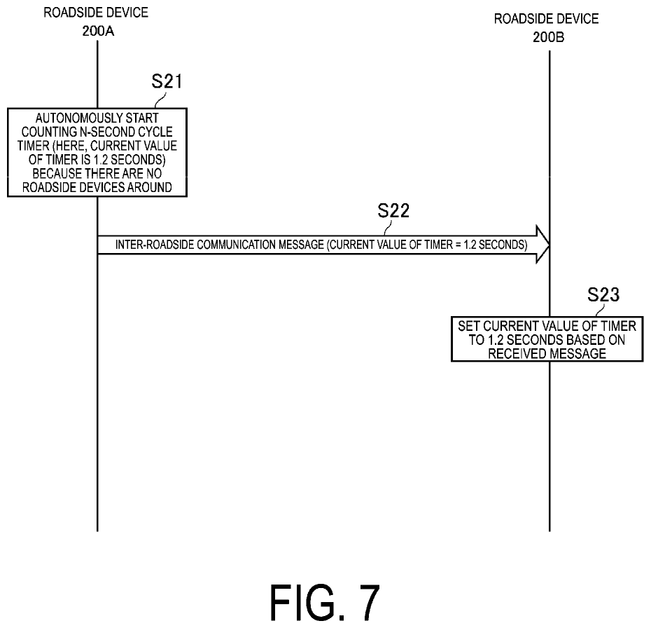

FIG. 7 is a diagram illustrating operation pattern 2 according to an embodiment. In the present operation pattern, of the roadside devices 200A and 200B, the roadside device 200A starts first, and subsequently the roadside device 200B starts.

As illustrated in FIG. 7, in Step S21, when the roadside device 200A starts, the controller 22 of the roadside device 200A determines whether the communicator 21 of the roadside device 200A has received the inter-roadside communication message. When the communicator 21 of the roadside device 200A cannot receive the inter-roadside communication message, the controller 22 of the roadside device 200A determines that there are no other roadside devices 200 around the roadside device 200A, and autonomously starts counting the N-second cycle timer.

In Step S22, the controller 22 of the roadside device 200A controls the communicator 21 of the roadside device 200A so as to transmit the inter-roadside communication message using broadcasting. Here, the controller 22 of the roadside device 200A controls the communicator 21 of the roadside device 200A so as to store the current value of the N-second cycle timer in a part of the transmission source MAC address field of the inter-roadside communication message. The communicator 21 of the roadside device 200B receives the inter-roadside communication message from the roadside device 200A. FIG. 7 illustrates an example in which the current value of the N-second cycle timer is 1.2 seconds.

In Step S23, the controller 22 of the roadside device 200B sets (modifies) the current value of the N-second cycle timer of the roadside device 200B, based on the inter-roadside communication message received by the communicator 21 of the roadside device 200B. Specifically, the controller 22 of the roadside device 200B makes the current value of the N-second cycle timer of the roadside device 200B match the current value stored in the transmission source MAC address field of the received inter-roadside communication message. With this configuration, the current values of the N-second cycle timers of the respective roadside devices 200A and 200B match.

Variations

Next, variations of the above-described embodiment will be described. The above-described embodiment describes an example of synchronizing the N-second cycle timers between the roadside devices 200. The present variation is an example for synchronizing frame timings between the roadside devices 200.

Methods for synchronizing the frame timings between the roadside devices 200 include two types of methods of GNSS synchronization using absolute time of GNSS and air synchronization using inter-roadside communication.

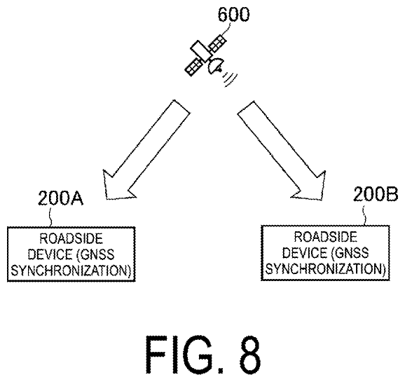

FIG. 8 is a diagram illustrating GNSS synchronization according to the present variation. As illustrated in FIG. 8, each of the roadside device 200A and the roadside device 200B performs frame timing synchronization using a GNSS signal received by the GNSS receiver 24 from a GNSS satellite 600. When each roadside device 200 can receive a GNSS signal, GNSS synchronization is the most reliable and most accurate synchronization method.

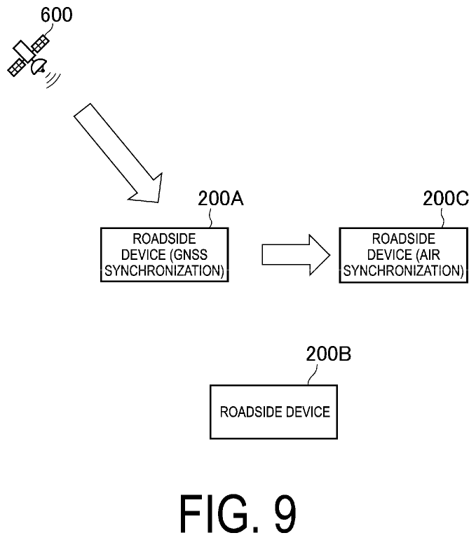

FIG. 9 is a diagram illustrating air synchronization according to the present variation. As illustrated in FIG. 9, the roadside device 200A performs frame timing synchronization using a GNSS signal received by the GNSS receiver 24 from the GNSS satellite 600. On the other hand, a roadside device 200C cannot receive the GNSS signal from the GNSS satellite 600, and cannot use GNSS synchronization. Thus, the roadside device 200C receives radio waves from the roadside device 200A being an adjacent roadside device 200, and performs frame timing synchronization using reception timing thereof. The roadside device 200C using such air synchronization basically controls the frame timing using a free running clock, and thus, this is a synchronization method less reliable and accurate than GNSS synchronization.

Under the condition illustrated in FIG. 9, it is assumed that the roadside device 200B cannot receive a GNSS signal. It is assumed that the roadside device 200B is present around the roadside devices 200A and 200C, and can receive the inter-roadside communication message from each of the roadside devices 200A and 200C.

In this case, there are two candidates of an air synchronization target of the roadside device 200B, that is, the roadside devices 200A and 200C. Here, a preferable air synchronization target of the roadside device 200B to be set by the roadside device 200B is the roadside device 200A during GNSS synchronization rather than the roadside device 200C during the air synchronization. In other words, it is not preferable that the roadside device 200B set the roadside device 200C during air synchronization as the air synchronization target of the roadside device 200B.

The following will describe operation of the roadside device 200 for enabling appropriate setting of the air synchronization target.

In the present variation, the synchronization information stored in the transmission source MAC address of the inter-roadside communication message transmitted by the roadside device 200A includes synchronization type information related to a synchronization target of the roadside device 200A. In the example illustrated in FIG. 9, the synchronization type information related to the synchronization target of the roadside device 200A is information indicating GNSS synchronization. The information indicating GNSS synchronization may be information indicating that the synchronization type is not air synchronization.

In the same manner and/or in a similar manner, the synchronization information stored in the transmission source MAC address of the inter-roadside communication message transmitted by the roadside device 200C includes the synchronization type information related to the synchronization target of the roadside device 200C. In the example illustrated in FIG. 9, the synchronization type information related to the synchronization target of the roadside device 200C is information indicating air synchronization. The information indicating air synchronization may be information indicating that the synchronization type is not GNSS synchronization.

(1) Operation Pattern 1

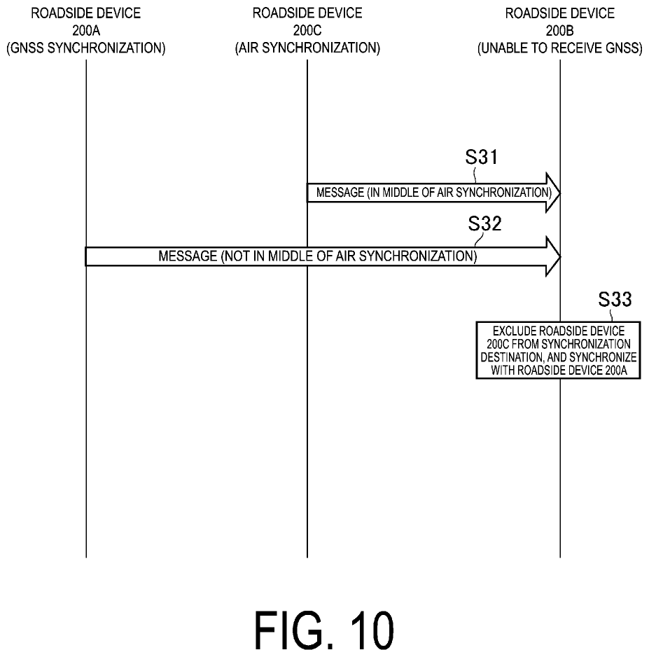

FIG. 10 is a diagram illustrating operation pattern 1 according to the present variation. In the present operation pattern, of the roadside devices 200A, 200B, and 200C, the roadside devices 200A and 200C start first, and subsequently the roadside device 200B starts. It is assumed that the roadside devices 200B and 200C are unable to receive a GNSS signal (that is, incapable of GNSS synchronization).

In Step S31, the controller 22 of the roadside device 200C controls the communicator 21 of the roadside device 200C so as to transmit the inter-roadside communication message using broadcasting. Here, the controller 22 of the roadside device 200C controls the communicator 21 of the roadside device 200C so as to store the synchronization type information indicating that the roadside device 200C is in the middle of air synchronization in a part of the transmission source MAC address field of the inter-roadside communication message. The communicator 21 of the roadside device 200B receives the inter-roadside communication message from the roadside device 200A.

In Step S32, the controller 22 of the roadside device 200A controls the communicator 21 of the roadside device 200A so as to transmit the inter-roadside communication message using broadcasting. Here, the controller 22 of the roadside device 200A controls the communicator 21 of the roadside device 200A so as to store the synchronization type information indicating that the roadside device 200A is in the middle of GNSS synchronization (not in the middle of air synchronization) in a part of the transmission source MAC address field of the inter-roadside communication message. The communicator 21 of the roadside device 200B receives the inter-roadside communication message from the roadside device 200A.

In Step S33, the controller 22 of the roadside device 200B sets the air synchronization target of the roadside device 200B, based on the synchronization type information stored in the MAC address field of the inter-roadside communication message received in Steps S31 and S32. Here, because the synchronization type information stored in the MAC address field of the inter-roadside communication message received from the roadside device 200C is information indicating air synchronization, the controller 22 of the roadside device 200B determines not to set the roadside device 200C as the air synchronization target of the roadside device 200B (that is, to exclude the roadside device 200C from the synchronization target of the roadside device 200B). On the other hand, because the synchronization type information stored in the MAC address field of the inter-roadside communication message received from the roadside device 200A is information indicating GNSS synchronization, the controller 22 of the roadside device 200A determines to set the roadside device 200A as the air synchronization target of the roadside device 200B.

(2) Operation Pattern 2

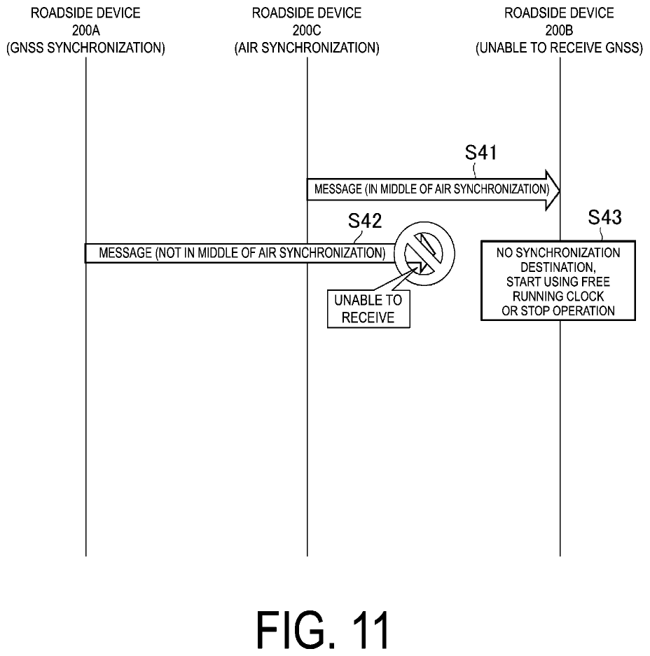

FIG. 11 is a diagram illustrating operation pattern 2 according to the present variation. In the present operation pattern, of the roadside devices 200A, 200B, and 200C, the roadside devices 200A and 200C start first, and subsequently the roadside device 200B starts. It is assumed that the roadside devices 200B and 200C are unable to receive a GNSS signal (that is, incapable of GNSS synchronization).

In Step S41, the controller 22 of the roadside device 200C controls the communicator 21 of the roadside device 200C so as to transmit the inter-roadside communication message using broadcasting. Here, the controller 22 of the roadside device 200C controls the communicator 21 of the roadside device 200C so as to store the synchronization type information indicating that the roadside device 200C is in the middle of air synchronization in a part of the transmission source MAC address field of the inter-roadside communication message. The communicator 21 of the roadside device 200B receives the inter-roadside communication message from the roadside device 200A.

In Step S42, the controller 22 of the roadside device 200A controls the communicator 21 of the roadside device 200A so as to transmit the inter-roadside communication message using broadcasting. Here, the controller 22 of the roadside device 200A controls the communicator 21 of the roadside device 200A so as to store the synchronization type information indicating that the roadside device 200A is in the middle of GNSS synchronization (not in the middle of air synchronization) in a part of the transmission source MAC address field of the inter-roadside communication message. However, the roadside device 200A is present far from the roadside device 200B, and the inter-roadside communication message from the roadside device 200A is not received in the roadside device 200B.

In Step S43, the controller 22 of the roadside device 200B sets the air synchronization target of the roadside device 200B, based on the synchronization type information stored in the MAC address field of the inter-roadside communication message received from the roadside device 200C in Step S41. Here, because the synchronization type information stored in the MAC address field of the inter-roadside communication message received from the roadside device 200C is information indicating air synchronization, the controller 22 of the roadside device 200B determines not to set the roadside device 200C as the air synchronization target of the roadside device 200B (that is, to exclude the roadside device 200C from the synchronization target of the roadside device 200B). In this case, the controller 22 of the roadside device 200B controls the frame timing using a free running clock. The controller 22 of the roadside device 200B may determine to stop operation of the roadside device 200B and stop transmission of radio waves.

### Other Embodiments

The above-described embodiment describes an example in which the communication system is the traffic communication system 1. However, the communication system may be another communication system such as a cellular communication system.

In the above-described embodiment, the server 400 may be an edge server disposed near the roadside device 200. Such an edge server may be considered part of roadside device 200. The edge server is provided between the roadside device 200 and the Internet and manages the road within an area limited to a predetermined range. The edge server may be connected to the roadside device 200 via a Local Area Network (LAN) without using a Wide Area Network (WAN).

A program that causes a computer to execute each of the processing operations according to the embodiments described above may be provided. The program may be recorded in a computer readable medium. The computer readable medium enables the program to be installed on a computer. Here, the computer readable medium on which the program is recorded may be a non-transitory recording medium. The non-transitory recording medium is not particularly limited, and may be, for example, a recording medium such as a CD-ROM, a DVD-ROM, or the like.

Embodiments have been described above in detail with reference to the drawings, but specific configurations are not limited to those described above, and design variations can be made without departing from the gist of the present embodiment.

1. A communication system for performing inter-base station communication being wireless communication between base stations, the communication system comprising:
a first base station configured to transmit a message comprising a medium access control (MAC) address field through inter-base station communication; and
a second base station configured to receive the message through the inter-base station communication, wherein
the first base station stores synchronization information in at least a part of the MAC address field, the synchronization information being information different from a MAC address and being used for synchronization between base stations.

2. The communication system according to claim 1, wherein
each of the first base station and the second base station is configured to manage a timer determining a transmission cycle in the inter-base station communication, and
the synchronization information comprises timer related information related to the timer managed by the first base station.

3. The communication system according to claim 2, wherein
the timer related information comprises a cycle value indicating the transmission cycle.

4. The communication system according to claim 3, wherein
the second base station is configured to make the transmission cycle of the second base station match the transmission cycle indicated by the cycle value stored in the MAC address field of the message received from the first base station.

5. The communication system according to claim 2, wherein
the timer related information comprises a current value of the timer.

6. The communication system according to claim 5, wherein
the second base station is configured to make the current value of the second base station match the current value stored in the MAC address field of the message received from the first base station.

7. The communication system according to claim 1, wherein
the synchronization information comprises synchronization type information related to a synchronization target of the first base station.

8. The communication system according to claim 7, wherein
when Global Navigation Satellite System (GNSS) synchronization using GNSS cannot be performed in the second base station, the second base station is configured to determine whether to set the first base station as the synchronization target of the second base station, based on the synchronization type information stored in the MAC address field of the message received from the first base station.

9. The communication system according to claim 8, wherein
when, in air synchronization, the synchronization target of the first base station is a base station other than the first base station, the synchronization information comprises information indicating the air synchronization, and
when the synchronization type information stored in the MAC address field of the message received from the first base station comprises information indicating the air synchronization, the second base station is configured to determine not to set the first base station as the synchronization target of the second base station.

10. The communication system according to claim 1, wherein
the MAC address field is a transmission source MAC address field in which the MAC address of the first base station is stored.

11. The communication system according to claim 1, wherein
the first base station is configured to transmit the message through the inter-base station communication using broadcasting.

12. The communication system according to claim 1, wherein
the message comprises an identifier identifying the first base station, and
the identifier is an identifier managed by a layer higher than a MAC layer.

13. A base station for performing inter-base station communication being wireless communication between base stations, the base station comprising:
a communicator configured to transmit a message comprising a medium access control (MAC) address field through inter-base station communication, wherein
the communicator is configured to store synchronization information in at least a part of the MAC address field, the synchronization information being information different from a MAC address and being used for synchronization between base stations.

14. A base station for performing inter-base station communication being wireless communication between base stations, the base station comprising:
a communicator configured to receive a message comprising a medium access control (MAC) address field through inter-base station communication, wherein
the communicator is configured to receive the message storing synchronization information in at least a part of the MAC address field, the synchronization information being information different from a MAC address and being used for synchronization between base stations.

15. A communication control method of performing inter-base station communication being wireless communication between base stations in a communication system, the communication control method comprising:
transmitting, by a first base station, a message comprising a medium access control (MAC) address field through inter-base station communication; and
receiving, by a second base station, the message through the inter-base station communication, wherein
the first base station stores synchronization information in at least a part of the MAC address field, the synchronization information being information different from a MAC address and being used for synchronization between base stations.
